(19) United States
(12) Patent Application Publication
(10) Pub. No.: US 2021/0201497 A1
(43) Pub. Date: Jul. 1, 2021

(54) METHOD FOR DETERMINING SEGMENTATION THRESHOLD OF DIGITAL IMAGE OF ROCK-SOIL MATERIAL

(71) Applicants: China University of Mining and Technology, Jiangsu (CN); XUZHOU JIANGHENG ENERGY TECHNOLOGY CO., LTD., Jiangsu (CN)

(72) Inventors: Jiangfeng LIU, Jiangsu (CN); Xulou CAO, Jiangsu (CN); Jianfu SHAO, Jiangsu (CN); Bingxiang HUANG, Jiangsu (CN); Gang WANG, Jiangsu (CN); Dawei HU, Jiangsu (CN); Liang CHEN, Jiangsu (CN); Shuliang CHEN, Jiangsu (CN)

(73) Assignees: China University of Mining and Technology, Jiangsu (CN); XUZHOU JIANGHENG ENERGY TECHNOLOGY CO., LTD., Jiangsu (CN)

(21) Appl. No.: 16/965,307

(22) PCT Filed: May 9, 2019
(86) PCT No.: PCT/CN2019/086147

§ 371 Date: Jul. 28, 2020

(30) Foreign Application Priority Data
Mar. 5, 2019 (CN) 201910174541.9

(51) Int. Cl. G06T 7/136; G06K 9/00

(52) U.S. Cl. CPC G06T 7/136; G06T 2207/30181; G06T 2207/10061; G06K 9/0063

(57) ABSTRACT

A method for determining a segmentation threshold of a digital image of a rock-soil material is disclosed. The method comprises the following steps: S1: acquiring a gray-level histogram curve of an SEM image of the rock-soil material; S2: determining a value range of a segmentation threshold T according to the gray-level histogram curve; S3: acquiring second derivatives of the gray-level histogram curve; and S4: determining the segmentation threshold T according to the second derivatives of the gray-level histogram curve and the value range of the segmentation threshold T. The present invention can rapidly and accurately determine the segmentation threshold of the digital image of the rock-soil material, and accurately distinguish a pore or fissure structure from a surface soil skeleton structure of the rock-soil material in the digital image.

### BACKGROUND

### Technical Field

The present invention relates to the field of image segmentation technologies, and in particular to a method for determining a segmentation threshold of a digital image of a rock-soil material.

### Description of Related Art

With the development of microscopic and mesoscopic imaging technologies, researchers can use the technologies to directly observe morphological characteristics of a pore structure in a rock-soil mass. Having a low test cost and a desired imaging effect, a scanning electron microscope (SEM) technology is gradually applied in many fields.

Surface microscopic pore structures of various rock-soil materials are directly observed by using the SEM technology, and permeability of the rock-soil materials is predicted through quantitative analysis. In a process of the quantitative analysis on an SEM image, a crucial step is to binarize the image. Binarization mainly aims to distinguish the pore structure from a surface soil skeleton structure of the rock-soil material in the SEM image, so as to extract the pore structure from the rock-soil material. Because the pore structure is the main factor that determines the permeability of the rock-soil material, how to accurately extract the pore structure is a critical technique during binarization of a digital image. Moreover, during the image binarization, a segmentation threshold of the image determines the accuracy of binarization for extraction of the pore structure. Therefore, it is of great significance to determine the segmentation threshold of the image.

In recent decades, many scholars at home and abroad have proposed a large number of calculation methods for determining a segmentation threshold during image binarization. However, the digital image is rather complicated, and image segmentation depends on specific situations in specific application fields. Therefore, until now, there is no universal algorithm for determining the segmentation threshold during binarization.

A Chinese patent, with publication No. CN 102841220 A and publication date on Dec. 26, 2012, discloses a porosity-based image segmentation method for an SEM picture of clay, which includes the following steps: measuring a dry density of a clay specimen by using a conventional experimental method in soil mechanics, and calculating the two-thirds power of the dry density; preparing a microstructure sample of the clay specimen in a laboratory; freeze-drying the prepared sample with a ZD-A3 freeze-drying instrument and evacuating the freeze-dried sample, scanning the sample with an SEM when its vacuum degree reaches 10⁻⁶ Pa, observing the microstructure of the sample, and obtaining a scanned picture; extracting binary data corresponding to two thresholds by using image analysis software; comparing parameter characteristics of particles and porosity extracted under the two threshold conditions, and calculating a volume-area ratio of pores; stopping approximation when the volume-area ratio of the pores equals to the two-thirds power of the dry density, and determining a threshold obtained in this case as an image segmentation threshold corresponding to the measured dry density. Advantageous effects of the method are as follows: The method realizes a scientific shift of parameters from three dimensions to two dimensions, and eliminates interference from human subjective factors, thus achieving a more accurate study on the soil microstructure. However, this invention has the following shortcomings. Although the threshold extracted based on the SEM picture by the Leica QWin image analysis software is artificially confirmed in the invention, multiple operations are required in the artificial confirmation process, making the process complex and error-prone. Therefore, this method is not conducive to long-term use.

### SUMMARY

Invention objective: In view of the problem that the process of determining a segmentation threshold during binarization of a digital image of a rock-soil material is complex and error-prone in the prior art, the present invention provides a method for determining a segmentation threshold of a digital image of a rock-soil material.

To achieve the objective of the present invention, the present invention adopts the following technical solutions:

A method for determining a segmentation threshold of a digital image of a rock-soil material is provided, which includes the following steps:

S1: acquiring a gray-level histogram curve of an SEM image of the rock-soil material;

S2: determining a value range of a segmentation threshold T according to the gray-level histogram curve;

S3: acquiring second derivatives of the gray-level histogram curve; and

S4: determining the segmentation threshold T according to the second derivatives of the gray-level histogram curve and the value range of the segmentation threshold T.

Further, before step S1 of acquiring the gray-level histogram curve of the image, the method further includes: reading the SEM image of the rock-soil material, to obtain each pixel gray level i in the SEM image and a total number nᵢ of pixels corresponding to each pixel gray level i.

Further, step S1 of acquiring the gray-level histogram curve of the image is specifically as follows:

S1.1: determining each pixel gray level i in a grayscale image of the rock-soil material;

S1.2: acquiring points on the gray-level histogram curve of the grayscale image of the rock-soil material according to the following formula:

$$P ( i ) = \frac{{n}_{i}}{N} , i = 0 , 1 , … , L - 1$$

where i indicates a gray level, N indicates a total number of image pixels, nᵢ indicates a total number of pixels having a gray level of i in the image, and L indicates the number of the gray levels; and

S1.3: performing fitting according to P(i) to obtain the gray-level histogram curve of the grayscale image of the rock-soil material.

Further, step S2 of determining the value range of the segmentation threshold T is specifically as follows:

step S2.1: determining the number of peaks in the gray-level histogram curve according to the gray-level histogram curve;

step S2.2: determining a structure of the rock-soil material according to the number of peaks;

step S2.3: acquiring a pixel gray level iₘₐₓ corresponding to the peak; and

step S2.4: determining the value range of the segmentation threshold T according to the structure of the rock-soil material and the pixel gray level iₘₐₓ corresponding to the peak.

Further, step S2.2 of determining the structure of the rock-soil material is specifically as follows:

if there is only one peak in the gray-level histogram curve, the rock-soil material has a pore structure; or

if there are two peaks in the gray-level histogram curve, the rock-soil material has a fissure structure.

Further, before step S3 of acquiring the second derivatives of the gray-level histogram curve, the method further includes: acquiring first derivatives of the gray-level histogram curve as follows:

$${v}_{i} = \frac{\partial {n}_{i}}{\partial i}$$

where i indicates a gray level, and nᵢ indicates a total number of pixels corresponding to each pixel gray level i in the image.

Further, the determining a segmentation threshold T of the pore structure is specifically as follows:

SA4.1: because the gray-level histogram curve has only one peak, determining a value range of the segmentation threshold T as:

T<iₘₐₓ

where iₘₐₓ is a pixel gray level corresponding to the peak;

SA4.2: acquiring second derivatives of the gray-level histogram curve as follows:

$${a}_{i} = \frac{{\partial }^{2} {n}_{i}}{\partial {i}^{2}}$$

where i indicates a gray level, and nᵢ indicates a total number of pixels corresponding to each pixel gray level i in the image;

SA4.3: determining a maximum value aᵢₘₐₓ of the second derivatives within the value range of the segmentation threshold T according to the second derivatives; and

SA4.4: determining a pixel gray level i_{T} corresponding to the maximum value aᵢₘₐₓ of the second derivatives, where the segmentation threshold T is:

T=i_{T}

where i_{T} is the pixel gray level corresponding to the maximum value aᵢₘₐₓ of the second derivatives.

Further, the determining a segmentation threshold T of the fissure structure is specifically as follows:

SB4.1: because the gray-level histogram curve has two peaks, determining a value range of the segmentation threshold T as:

iₘₐₓ₁<T<iₘₐₓ₂

where iₘₐₓ₁ is a pixel gray level corresponding to the first peak and iₘₐₓ₂ is a pixel gray level corresponding to the second peak;

SB4.2: acquiring second derivatives of the gray-level histogram curve as follows:

$${a}_{i} = \frac{{\partial }^{2} {n}_{i}}{\partial {i}^{2}}$$

where nᵢ indicates a total number of pixels having a gray level of I in the image, and i indicates a gray level;

SB4.3: determining a maximum value aᵢₘₐₓ of the second derivatives within the value range of the segmentation threshold T according to the second derivatives; and

SB4.4: determining a pixel gray level i_{T} corresponding to the maximum value aᵢₘₐₓ of the second derivatives, where the segmentation threshold T is:

T=i_{T}

where i_{T} is the pixel gray level corresponding to the maximum value aᵢₘₐₓ of the second derivatives.

Compared with the prior art, the technical solutions of the present invention have the following advantageous technical effects:

(1) In the present invention, first, a value range of a segmentation threshold is determined according to a gray-level histogram curve of an SEM image of a rock-soil material to be tested, and then a specific value of the segmentation threshold is determined according to second derivatives of the gray-level histogram curve. The range is continuously narrowed until an accurate value is determined, thus further guaranteeing accuracy of the segmentation threshold.

(2) The present invention makes analysis based on the SEM image of the rock-soil material to be tested, so that the segmentation threshold is guaranteed to meet a requirement of binarization of a digital image of the rock-soil material to be tested. In this way, a pore or fissure structure and a surface soil skeleton structure of the rock-soil material can be accurately distinguished from each other in the digital image.

(3) The present invention provides an accurate segmentation threshold for future in-depth research based on a digital image into the rock-soil material, and further provides an effective technical support for accurate extraction of the pore or fissure structure from the rock-soil material.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic flowchart of the present invention;

FIG. 2 shows an SEM image of bentonite;

FIG. 3 is a schematic diagram of basic units of bentonite particles;

FIG. 4 is a schematic sectional diagram showing a principle of SEM scanning of a rock-soil material;

FIG. 5 is a schematic diagram showing a correspondence between a gray-level histogram curve and structures in a rock-soil mass;

FIG. 6 shows binary images of compacted bentonite at different segmentation thresholds;

FIG. 7 shows a binary extraction process as an SEM image increases with a segmentation threshold;

FIG. 8 shows an SEM image of a fractured coal sample;

FIG. 9 shows a gray-level histogram curve of the fractured coal sample;

FIG. 10 shows a gray-level histogram curve of the bentonite;

FIG. 11 shows a second derivative curve of the gray-level histogram curve of the bentonite;

FIG. 12 shows a final binary image of the bentonite;

FIG. 13 shows a second derivative curve of the gray-level histogram curve of the fractured coal sample; and

FIG. 14 shows a final binary image of the fractured coal sample.

### DESCRIPTION OF THE EMBODIMENTS

To make the objective, technical solutions, and advantages of the present invention clearer, the technical solutions in the embodiments of the present invention are clearly and completely described below with reference to the accompanying drawings of the embodiments of the present invention. The described embodiments are some rather than all of the embodiments of the present invention. Therefore, the following detailed description of the embodiments of the present invention provided in the accompanying drawings is not intended to limit the scope of the present invention for which protection is claimed, but merely represents selected embodiments of the present invention.

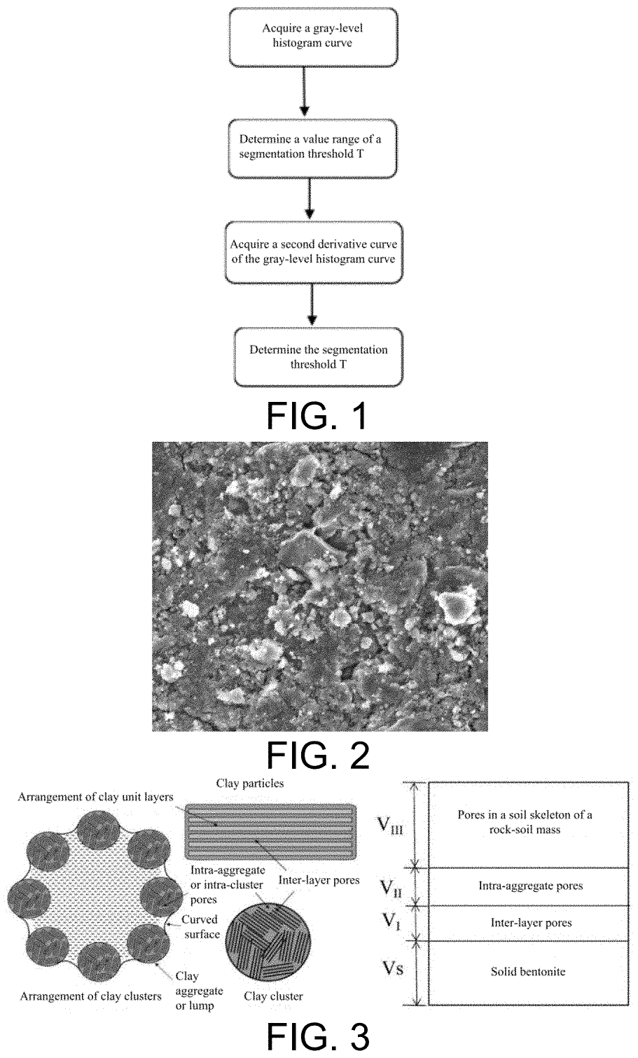

Referring to FIG. 1, this embodiment provides a method for determining a segmentation threshold of a digital image of a rock-soil material. The segmentation threshold calculated by using the method can be used to effectively extract a pore or fissure structure from an SEM image, and the extracted structure is consistent with an actual distribution of pores or fractures in the rock-soil material, thus providing a sound technical support for mesoscopic study on the mechanism of the rock-soil material based on a digital image approach.

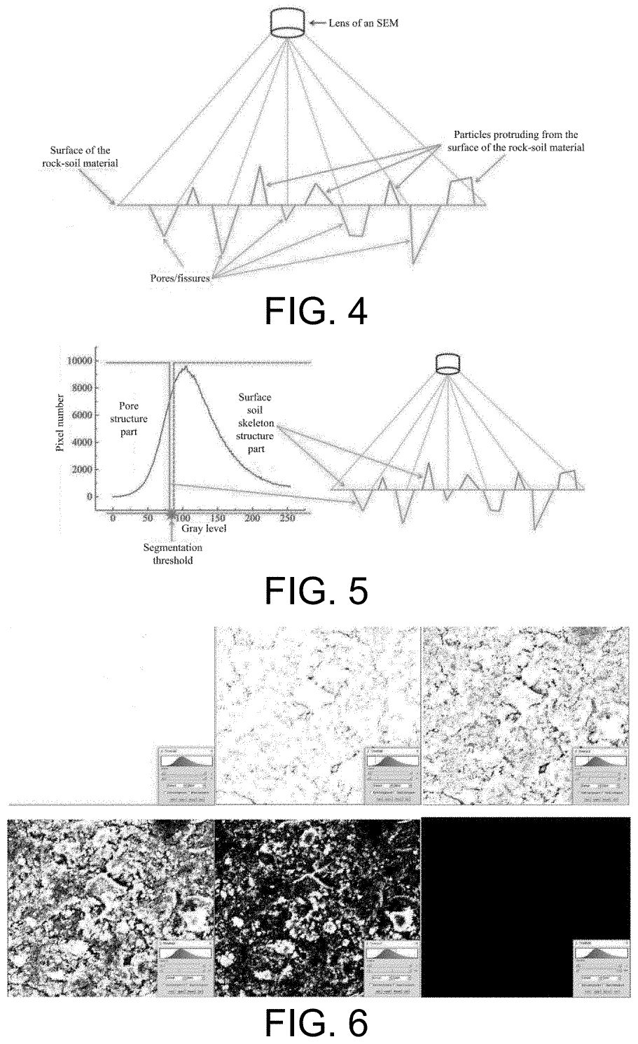

Referring to FIG. 4, FIG. 4 shows that an SEM scans the surface of a sample with a focused beam of electrons to produce a sample surface image, where the SEM is an abbreviation for Scanning Electron Microscope which is a type of electron microscope.

A surface microstructure image of the rock-soil material that is obtained by scanning with the SEM is a grayscale image. Gray levels of the grayscale image are from 0 to 255, and have a total of 256 values. Moreover, the depth of a color of each pixel point in the SEM image represents a gray level.

Because the pore or fissure structure of the rock-soil material is far away from an electron beam ejection port, gray levels of pixel points representing the pore or fissure structure in a final SEM image are generally from 0 to 90. However, because particles protruding from a surface soil skeleton structure of the rock-soil material are relatively close to the electron beam ejection port, gray levels of pixel points representing the surface soil skeleton structure of the rock-soil material in the final image are generally from 150 to 255. In addition, the surface soil skeleton structure occupies a large proportion in the rock-soil material, which specifically accounts for more than 50% and is in the same plane. Therefore, gray levels thereof are generally from 90 to 150 and are corresponding to a maximum number of pixels.

In this embodiment, specifically, the method for determining a segmentation threshold specifically includes the following steps:

Step S1: An SEM image of a rock-soil material to be tested is read by using MATALB codes, to obtain each pixel gray level i in the SEM image and a total number nᵢ of pixels corresponding to each pixel gray level i.

Step S2: A gray-level histogram curve of the SEM image of the rock-soil material to be tested is acquired, which specifically includes the following process:

Step S2.1: Points on the gray-level histogram curve of a grayscale image of the rock-soil material to be tested are acquired according to each pixel gray level i, the total number nᵢ of pixels corresponding to each pixel gray level i, and the following formula:

$$P ( i ) = \frac{{n}_{i}}{N} , i = 0 , 1 , … , L - 1$$

where i indicates a gray level, N indicates a total number of image pixels, nᵢ indicates a total number of pixels having a gray level of i in the image, and L indicates the number of the gray levels.

Step S2.2: Fitting is performed according to the points P(i) obtained in step S2.1, to obtain the gray-level histogram curve of the grayscale image of the rock-soil material.

Step S3: A value range of a segmentation threshold T is determined according to the gray-level histogram curve, which specifically includes the following process:

Step S3.1: The number of peaks in the gray-level histogram curve is determined according to the gray-level histogram curve.

Step S3.2: A structure of the rock-soil material to be tested is determined according to the number of peaks, which is specifically as follows:

If there is only one peak in the gray-level histogram curve, the rock-soil material to be tested has a pore structure; or
if there are two peaks in the gray-level histogram curve, the rock-soil material to be tested has a fissure structure.

Step S3.3: According to the number of the peaks, a pixel gray level iₘₐₓ corresponding to the corresponding peak is acquired.

Step S3.4: The value range of the segmentation threshold T is determined according to the structure of the rock-soil material to be tested and the pixel gray level iₘₐₓ corresponding to the corresponding peak.

It should be noted that, because the structure of the rock-soil material to be tested is not determined, the value range of the segmentation threshold T also cannot be determined, which depends on the structure and the number of corresponding peaks.

Step S4: Second derivatives of the gray-level histogram curve are acquired, which specifically includes the following process:

Step S4.1: First derivatives of the gray-level histogram curve are acquired as follows:

$${v}_{i} = \frac{\partial {n}_{i}}{\partial i}$$

where i indicates a gray level, and nᵢ indicates a total number of pixels corresponding to each pixel gray level i in the image.

Step S4.2: Second derivatives of the gray-level histogram curve are acquired as follows:

$${a}_{i} = \frac{{\partial }^{2} {n}_{i}}{\partial {i}^{2}}$$

where i indicates a gray level, and nᵢ indicates a total number of pixels corresponding to each pixel gray level i in the image.

Step S5: The segmentation threshold T is determined according to the second derivatives of the gray-level histogram curve and the value range of the segmentation threshold T, which specifically includes the following process:

Step S5.1: Fitting is performed according to aᵢ obtained in step S4.2, to obtain a second derivative curve.

Step S5.2: A maximum value aᵢₘₐₓ within the value range of the segmentation threshold T is determined in the second derivative curve, and a pixel gray level i_{T} corresponding to the maximum value aᵢₘₐₓ is also determined, where the segmentation threshold T is:

T=i_{T}
where i_{T} is the pixel gray level corresponding to the maximum value of the second derivatives.

### Embodiment 1 Rock-Soil Material Having a Pore Structure

This embodiment provides a method for determining a segmentation threshold of a digital image of a rock-soil material. In this embodiment, specifically, bentonite is selected as the rock-soil material to be tested. A method for determining a segmentation threshold of a digital image of the bentonite specifically includes the following steps:

Step SA1: Referring to FIG. 2, FIG. 2 shows an SEM image of bentonite. An SEM image of the bentonite is read by using MATALB codes, to obtain each pixel gray level i in the SEM image of the bentonite and a total number nᵢ of pixels corresponding to each pixel gray level i.

Step SA2: A gray-level histogram curve of the SEM image of the bentonite is acquired, which specifically includes the following process:

Step SA2.1: Points on the gray-level histogram curve of a grayscale image of the bentonite are acquired according to each pixel gray level i, the total number nᵢ of pixels corresponding to each pixel gray level i, and the following formula:

$$P ( i ) = \frac{{n}_{i}}{N} , i = 0 , 1 , … , L - 1$$

where i indicates a gray level, N indicates a total number of image pixels, nᵢ indicates a total number of pixels having a gray level of i in the image, and L indicates the number of the gray levels.

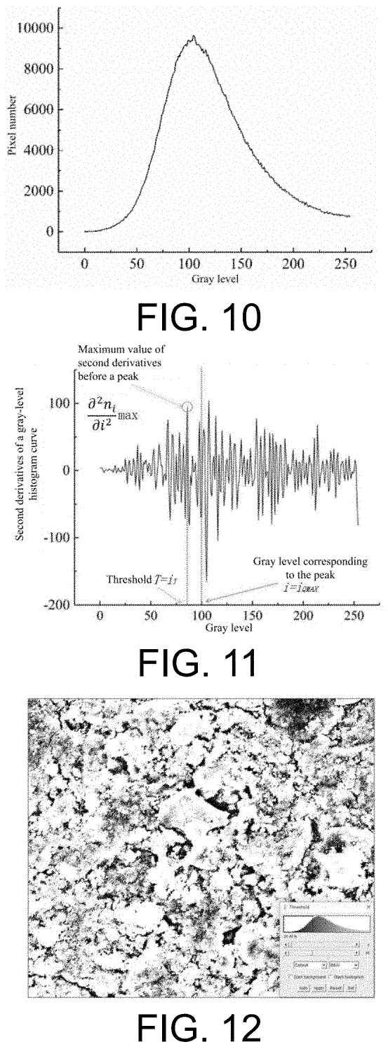

Step SA2.2: Fitting is performed according to the points P(i) obtained in step SA2.1, to obtain the gray-level histogram curve of the grayscale image of the bentonite. Referring to FIG. 10, FIG. 10 shows a gray-level histogram curve of the bentonite. The proportion of the number of pixels corresponding to each gray level i in the SEM image of the bentonite can be intuitively seen from the gray-level histogram curve of the bentonite.

Step SA3: A value range of a segmentation threshold T is determined according to the gray-level histogram curve, which specifically includes the following process:

Step SA3.1: The number of peaks in the gray-level histogram curve is determined according to the gray-level histogram curve. In this embodiment, it can be known from FIG. 10 that, there is only one peak in the gray-level histogram curve, and therefore the bentonite has a pore structure.

Through testing by using a mercury intrusion method and an automatic core-compression pore-seepage test system, it is learned that the porosity of the rock-soil mass is less than 30%, which indicates that the pore structure occupies a small proportion compared to a surface soil skeleton structure. In this embodiment, specifically, through testing by using the mercury intrusion method and the automatic core-compression pore-seepage test system, it is learned that the porosity of dried and compacted bentonite is 20% to 30%. For the SEM image of the bentonite, the proportion of the pore structure therein should be around 25%. It can be learned from FIG. 3 that the pore structure of the bentonite has several different layers. The pore structure of the bentonite observed by scanning with the SEM belongs to a surface microscopic pore structure, and therefore the porosity tested using a digital image approach should be less than 20%.

Step SA3.2: Because it is learned from step SA3.1 that there is only one peak in the gray-level histogram curve of the bentonite, it is only required to determine a pixel gray level iₘₐₓ corresponding to the peak in this embodiment.

Step SA3.3: The value range of the segmentation threshold T is determined according to the structure of the bentonite and the pixel gray level iₘₐₓ corresponding to the peak. Because the bentonite has a pore structure and there is only one peak in the gray-level histogram curve, the value range of the segmentation threshold T of the digital image of the bentonite is as follows:

T<iₘₐₓ
where iₘₐₓ is a pixel gray level corresponding to the peak.

Referring to FIG. 5, because all gray-level histograms of rock-soil materials having a pore structure are unimodal curves, the bentonite has a pore structure. Because the surface soil skeleton occupies a large proportion, pixels corresponding to the peak certainly belong to the surface soil skeleton. It should be noted that, through testing by using the mercury intrusion method and the automatic core-compression pore-seepage test system, it is learned that the porosity of the dried and compacted bentonite is less than 30%. Therefore, pixels representing the pore structure in the digital image of the bentonite certainly account for less than 30%, and thus the surface soil skeleton structure accounts for more than 70% in the bentonite. Therefore, the pixels corresponding to the peak in the gray-level histogram certainly represent the surface soil skeleton. Definitely, gray levels corresponding to the pore structure are generally from 0 to 90, and the remaining gray levels from 90 to 225 are corresponding to the surface soil skeleton structure. Therefore, gray levels of pixels representing the pore structure are less than gray levels of pixels representing the surface soil skeleton structure.

Referring to FIG. 6, FIG. 6 shows a change process of a binary image of compacted bentonite as the segmentation threshold T gradually increases from 0 to 255. In FIG. 6, the black parts represent pore structures extracted according to different segmentation thresholds, and some of the pore structures are obviously rather unreasonable. However, it can be observed through such a change process that the porosity also increases as the segmentation threshold T increases.

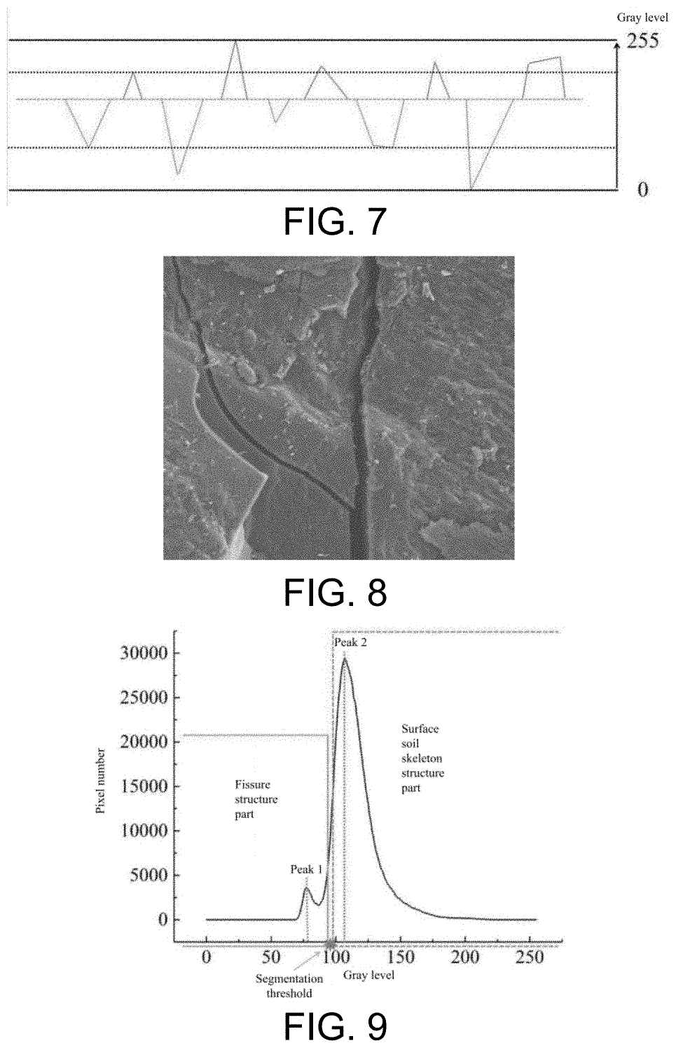

Referring to FIG. 7, FIG. 7 shows a process in which the binary image changes with the segmentation threshold T, where an increase in porosity in the binary image actually means that black pixels in the image increase in number as the segmentation threshold T increases. Because the surface soil skeleton structure occupies a large proportion, when the segmentation threshold T increases from a gray level corresponding to the pore structure to a gray level corresponding to the surface soil skeleton structure, a total number nᵢ of pixels corresponding to each pixel gray level i may have a sudden change in the image. Therefore, a gray level i corresponding to a point of the sudden change from the pore structure to the surface soil skeleton structure can be determined as the segmentation threshold T.

Step SA4: Second derivatives of the gray-level histogram curve are acquired, which specifically includes the following process:

Step SA4.1: First derivatives of the gray-level histogram curve are acquired as follows:

$${v}_{i} = \frac{\partial {n}_{i}}{\partial i}$$

where i indicates a gray level, and nᵢ indicates a total number of pixels corresponding to each pixel gray level i in the image.

Step SA4.2: Second derivatives of the gray-level histogram curve are acquired as follows:

$${a}_{i} = \frac{{\partial }^{2} {n}_{i}}{\partial {i}^{2}}$$

where i indicates a gray level, and nᵢ indicates a total number of pixels corresponding to each pixel gray level i in the image.

Step SA5: The segmentation threshold T is determined according to the second derivatives aᵢ of the gray-level histogram curve and the value range of the segmentation threshold T, which specifically includes the following process:

Step SA5.1: Fitting is performed according to aᵢ obtained in step SA4.2, to obtain a second derivative curve. Referring to FIG. 11, FIG. 11 shows a second derivative curve of the gray-level histogram curve of the bentonite.

Step SA5.2: A maximum value aᵢₘₐₓ within the value range of the segmentation threshold T is determined in the second derivative curve, and a pixel gray level i_{T} corresponding to the maximum value aᵢₘₐₓ is also determined, where the segmentation threshold T is:

T=i_{T}
where i_{T} is the pixel gray level corresponding to the maximum value of the second derivatives.

Referring to FIG. 12, FIG. 12 shows a final binary image of the bentonite, in which the segmentation threshold T is i_{T}. Therefore, in the gray-level histogram curve of the bentonite, a range corresponding to gray levels i less than the segmentation threshold T represents the pore structure in the bentonite, while a range corresponding to gray levels i greater than the segmentation threshold T represents the surface soil skeleton structure in the bentonite.

### Embodiment 2 Rock-Soil Material Having a Fissure Structure

This embodiment provides a method for determining a segmentation threshold of a digital image of a rock-soil material. In this embodiment, specifically, a fractured coal sample is selected as the rock-soil material to be tested. A method for determining a segmentation threshold of a digital image of the fractured coal sample specifically includes the following steps:

Step SB1: Referring to FIG. 8, FIG. 8 shows an SEM image of the fractured coal sample. An SEM image of the fractured coal sample is read by using MATALB codes, to obtain each pixel gray level i in the SEM image of the fractured coal sample and a total number nᵢ of pixels corresponding to each pixel gray level i.

Step SB2: A gray-level histogram curve of the SEM image of the fractured coal sample is acquired, which specifically includes the following process:

Step SB2.1: Points on the gray-level histogram curve of a grayscale image of the fractured coal sample are acquired according to each pixel gray level i, the total number nᵢ of pixels corresponding to each pixel gray level i, and the following formula:

$$P ( i ) = \frac{{n}_{i}}{N} , i = 0 , 1 , … , L - 1$$

where i indicates a gray level, N indicates a total number of image pixels, nᵢ indicates a total number of pixels having a gray level of i in the image, and L indicates the number of the gray levels.

Step SB2.2: Fitting is performed according to the points P(i) obtained in step SB2.1, to obtain the gray-level histogram curve of the grayscale image of the fractured coal sample. Referring to FIG. 9, FIG. 9 shows a gray-level histogram curve of the SEM image of the fractured coal sample.

Step SB3: A value range of a segmentation threshold T is determined according to the gray-level histogram curve, which specifically includes the following process:

Step SB3.1: The number of peaks in the gray-level histogram curve is determined according to the gray-level histogram curve. In this embodiment, it can be known from FIG. 9 that there are two peaks in the gray-level histogram curve, and therefore the fractured coal sample has a fissure structure.

Step SB3.2: Because it is learned from step SB3.1 that there are two peaks in the gray-level histogram curve of the fractured coal sample, it is required to determine pixel gray levels iₘₐₓ₁ and iₘₐₓ₂ respectively corresponding to the two peaks in this embodiment, where iₘₐₓ₁ is a pixel gray level corresponding to the first peak and iₘₐₓ₂ is a pixel gray level corresponding to the second peak.

Step SB3.3: The value range of the segmentation threshold T is determined according to the structure of the fractured coal sample and the pixel gray levels iₘₐₓ₁ and iₘₐₓ₂ corresponding to the peaks. Because the fractured coal sample has a fissure structure and there are two peaks in the gray-level histogram curve thereof, the value range of the segmentation threshold T of the digital image of the fractured coal sample is as follows:

iₘₐₓ₁≤T<iₘₐₓ₂
where iₘₐₓ₁ is a pixel gray level corresponding to the first peak and iₘₐₓ₂ is a pixel gray level corresponding to the second peak.

Referring to FIG. 9, because gray-level histogram curves of rock-soil materials having a fissure structure are all bimodal curves, the fractured coal sample is a rock-soil material having a fissure structure. As the gray level i gradually increases, pixels corresponding to the first peak in the image represent pixels of a fissure, while pixels corresponding to the second peak represent pixels of a surface skeleton. Therefore, the segmentation threshold T of the rock-soil material having a fissure structure is between the two peaks.

Step SB4: Second derivatives of the gray-level histogram curve are acquired, which specifically includes the following process:

Step SB4.1: First derivatives of the gray-level histogram curve are acquired as follows:

$${v}_{i} = \frac{\partial {n}_{i}}{\partial i}$$

where i indicates a gray level, and nᵢ indicates a total number of pixels corresponding to each pixel gray level i in the image.

Step SB4.2: Second derivatives of the gray-level histogram curve are acquired as follows:

$${a}_{i} = \frac{{\partial }^{2} {n}_{i}}{\partial {i}^{2}}$$

where i indicates a gray level, and nᵢ indicates a total number of pixels corresponding to each pixel gray level i in the image.

Step SB5: The segmentation threshold T is determined according to the second derivatives aᵢ of the gray-level histogram curve and the value range of the segmentation threshold T, which specifically includes the following process:

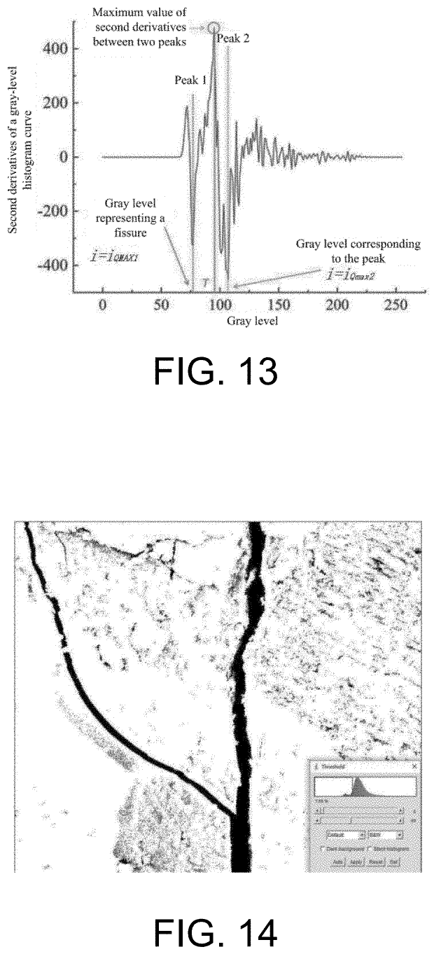

Step SB5.1: Fitting is performed according to aᵢ obtained in step SB4.2, to obtain a second derivative curve. Referring to FIG. 13, FIG. 13 shows a second derivative curve of the gray-level histogram curve of the fractured coal sample.

Step SB5.2: A maximum value aᵢₘₐₓ within the value range of the segmentation threshold T is determined in the second derivative curve, and a pixel gray level i_{T} corresponding to the maximum value aᵢₘₐₓ is also determined, where the segmentation threshold T is:

T=i_{T}
where i_{T} is the pixel gray level corresponding to the maximum value of the second derivatives.

Referring to FIG. 14, FIG. 14 shows a final binary image of the fractured coal sample, in which the segmentation threshold T is i_{T}. Therefore, in the gray-level histogram curve of the fractured coal sample, a range corresponding to gray levels i less than the segmentation threshold T represents the fissure structure in the fractured coal sample, while a range corresponding to gray levels i greater than the segmentation threshold T represents the surface soil skeleton structure in the fractured coal sample.

The present invention and its implementations have been illustratively described above, but the description is not restrictive. The accompanying drawings merely show one of the implementations of the present invention, and the actual structure and methods are not limited thereto. Therefore, structural modes and embodiments similar to the technical solutions of the present invention that are designed by persons of ordinary skill in the art without creative efforts and departing from the purpose of the present invention after gaining enlightenment from the present invention all fall within the scope of protection of the present invention.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A method for determining a segmentation threshold of a digital image of a rock-soil material, comprising the following steps:
S1: acquiring a gray-level histogram curve of an SEM image of the rock-soil material;
S2: determining a value range of a segmentation threshold T according to the gray-level histogram curve;
S3: acquiring second derivatives of the gray-level histogram curve; and
S4: determining the segmentation threshold T according to the second derivatives of the gray-level histogram curve and the value range of the segmentation threshold T.

2. The method for determining a segmentation threshold of a digital image of a rock-soil material according to claim 1, wherein before the step S1 of acquiring the gray-level histogram curve of the SEM image, the method further comprises: reading the SEM image of the rock-soil material to obtain each pixel gray level i in the SEM image and a total number nᵢ of pixels corresponding to each pixel gray level i.

3. The method for determining a segmentation threshold of a digital image of a rock-soil material according to claim 1, wherein the step S1 of acquiring the gray-level histogram curve of the SEM image is specifically as follows:
S1.1: determining each pixel gray level i in a grayscale image of the rock-soil material;
S1.2: acquiring points on the gray-level histogram curve of the grayscale image of the rock-soil material according to the following formula:
$$P ( i ) = \frac{{n}_{i}}{N} , i = 0 , 1 , … , L - 1$$
wherein i indicates a gray level, N indicates a total number of image pixels, nᵢ indicates a total number of pixels having a gray level of i in the SEM image, and L indicates the number of the gray levels; and
S1.3: performing fitting according to P(i) to obtain the gray-level histogram curve of the grayscale image of the rock-soil material.

4. The method for determining a segmentation threshold of a digital image of a rock-soil material according to claim 3, wherein the step S2 of determining the value range of the segmentation threshold T is specifically as follows:
step S2.1: determining a number of peaks in the gray-level histogram curve according to the gray-level histogram curve;
step S2.2: determining a structure of the rock-soil material according to the number of peaks;
step S2.3: acquiring a pixel gray level iₘₐₓ corresponding to the peak; and
step S2.4: determining the value range of the segmentation threshold T according to the structure of the rock-soil material and the pixel gray level iₘₐₓ corresponding to the peak.

5. The method for determining a segmentation threshold of a digital image of a rock-soil material according to claim 4, wherein the step S2.2 of determining the structure of the rock-soil material is specifically as follows:
if there is only one peak in the gray-level histogram curve, the rock-soil material has a pore structure; or
if there are two peaks in the gray-level histogram curve, the rock-soil material has a fissure structure.

6. The method for determining a segmentation threshold of a digital image of a rock-soil material according to claim 5, wherein before the step S3 of acquiring the second derivatives of the gray-level histogram curve, the method further comprises: acquiring first derivatives of the gray-level histogram curve as follows:
$${v}_{i} = \frac{\partial {n}_{i}}{\partial i}$$
wherein i indicates a gray level, and nᵢ indicates a total number of pixels corresponding to each pixel gray level i in the SEM image.

7. The method for determining a segmentation threshold of a digital image of a rock-soil material according to claim 6, wherein the determining the segmentation threshold T of the pore structure is specifically as follows:
SA4.1: only one peak being in the gray-level histogram curve, determining a value range of the segmentation threshold T as:
T<iₘₐₓ
wherein iₘₐₓ is a pixel gray level corresponding to the peak;
SA4.2: acquiring second derivatives of the gray-level histogram curve as follows:
$${a}_{i} = \frac{{\partial }^{2} {n}_{i}}{\partial {i}^{2}}$$
wherein i indicates a gray level, and nᵢ indicates a total number of pixels corresponding to each pixel gray level i in the SEM image;
SA4.3: determining a maximum value aᵢₘₐₓ of the second derivatives within the value range of the segmentation threshold T according to the second derivatives; and
SA4.4: determining a pixel gray level i_{T} corresponding to the maximum value aᵢₘₐₓ of the second derivatives, wherein the segmentation threshold T is:
T=i_{T}
wherein i_{T} is the pixel gray level corresponding to the maximum value aᵢₘₐₓ of the second derivatives.

8. The method for determining a segmentation threshold of a digital image of a rock-soil material according to claim 6, wherein the determining a segmentation threshold T of the fissure structure is specifically as follows:
SB4.1: two peaks being in the gray-level histogram curve, determining a value range of the segmentation threshold T as:
iₘₐₓ₁<T<iₘₐₓ₂
wherein iₘₐₓ₁ is a pixel gray level corresponding to the first peak and iₘₐₓ₂ is a pixel gray level corresponding to the second peak;
SB4.2: acquiring second derivatives of the gray-level histogram curve as follows:
$${a}_{i} = \frac{{\partial }^{2} {n}_{i}}{\partial {i}^{2}}$$
wherein nᵢ indicates a total number of pixels all having a gray level of i in the SEM image, and i indicates a gray level;
SB4.3: determining a maximum value aᵢₘₐₓ of the second derivatives within the value range of the segmentation threshold T according to the second derivatives; and
SB4.4: determining a pixel gray level i_{T} corresponding to the maximum value aᵢₘₐₓ of the second derivatives, wherein the segmentation threshold T is:
T=i_{T}
wherein i_{T} is the pixel gray level corresponding to the maximum value aᵢₘₐₓ of the second derivatives.

9. The method for determining a segmentation threshold of a digital image of a rock-soil material according to claim 2, wherein the step S1 of acquiring the gray-level histogram curve of the SEM image is specifically as follows:
S1.1: determining the each pixel gray level i in a grayscale image of the rock-soil material;
S1.2: acquiring points on the gray-level histogram curve of the grayscale image of the rock-soil material according to the following formula:
$$P ( i ) = \frac{{n}_{i}}{N} , i = 0 , 1 , … , L - 1$$
wherein i indicates a gray level, N indicates a total number of image pixels, nᵢ indicates a total number of pixels having a gray level of i in the SEM image, and L indicates the number of the gray levels; and
S1.3: performing fitting according to P(i) to obtain the gray-level histogram curve of the grayscale image of the rock-soil material.
